(19) United States
(12) Patent Application Publication
(10) Pub. No.: US 2007/0108904 A1
(43) Pub. Date: May 17, 2007

(54) Plasma display panel (PDP) having increased degree of pixel integration

(76) Inventor: Sanghoon Yim, Yongin-si (KR)

Correspondence Address: Robert E. Bushnell, Suite 300, 1522 K Street, N.W., Washington, DC, 20005, US

(21) Appl. No.: 11/583,772

(22) Filed: Oct. 20, 2006

(30) Foreign Application Priority Data
Nov. 15, 2005 (KR) 10-2005-0108980

(51) Int. Cl. H01J 17/49

(52) U.S. Cl. 313/582

(57) ABSTRACT

A Plasma Display Panel (PDP) has a structure in which three discharge cells are adjacent one another and are arranged in a triangular form, thereby forming one pixel. In pixels arranged in a first direction, an average of 1.5 address electrodes are assigned which belong to the group of electrodes and have a specific angle in the first direction with respect to a surface parallel to the substrates, and at least four sustain electrodes pass through each pixel. Accordingly, the number of address electrodes for implementing a screen having the same horizontal resolution and the number of driving circuit chips required to drive the address electrodes can be reduced, thereby reducing overall power consumption and heat release rate.

### ClAIM OF PRIORITY

This application makes reference to, incorporates the same herein, and claims all benefits accruing under 35 U.S.C. §119 from an application for PLASMA DISPLAY PANEL FOR INCREASING THE DEGREE OF INTEGRATION OF PIXEL earlier filed in the Korean Intellectual Property Office on the 15 of Nov. 2005 and there duly assigned Serial No. 10-2005-0108980.

### BACKGROUND OF THE INVENTION

1. Field of the Invention

The present invention relates to a Plasma Display Panel (PDP), and more particularly, to a PDP having an increased degree of pixel integration in a horizontal direction of a screen through an electrode arrangement and a barrier rib structure.

2. Description of the Related Art

Plasma display devices are flat display devices using a Plasma Display Panel (hereinafter referred to as a PDP or a panel) in which a barrier rib and a driving electrode are formed between two substrates facing each other, the substrates are spaced apart by a specific gap, a discharge gas is infused therein, and the substrates are sealed. In a plasma display device, a PDP is formed, and elements required for implementing a screen are then installed, such as a driving circuit connected to each electrode of the panel.

In the PDP, a number of pixels for displaying the screen are vertically and horizontally arranged in cyclical and regular manners to form a matrix pattern. Each pixel is driven in a manual matrix manner in which a voltage is simply supplied to electrodes without any active elements for driving the pixels. According to the type of a voltage signal for driving each electrode, the PDP can be classified as either a Direct Current (DC) PDP or an Alternating Current (AC) PDP. In addition, according to the disposition of two electrodes to which a discharge voltage is supplied, the PDP can be classified as either a face type PDP or a surface discharge type PDP.

In the case of the AC PDP, electrodes are covered by a dielectric layer so that the electrodes naturally have electrostatic capacity, a current flowing through the electrodes is limited, and the electrodes are easily protected from ion bombardment when a discharge takes place. As a result, a lifespan of the electrodes is extended. In a typical AC face discharge type PDP, a plurality of address electrodes is vertically formed on the inner side of one of the two substrates so as to be parallel to one another. A common electrode and a scan electrode, which can be respectively referred to as a sustain electrode and a display electrode, are alternately horizontally formed on the inner side of the same substrate or the other substrate to be parallel to each other.

In general, a matrix type pixel arrangement is formed by considering a barrier rib and an electrode formation. One color pixel includes three discharge cells representing separate visible light beams of different colors. Three color pixels can be disposed side by side, or disposed in a triangular form. The discharge cells can be formed in a rectangular or hexagonal form.

The barrier rib can be a stripe type in which the barrier rib is formed in a straight line parallel to an address electrode in a column direction, a grid type in which each cell is arranged in a row direction and a column direction to define one cell. Furthermore, the barrier rib can have a meander structure in which the stripe type and the grid type are combined, and a discharge cell is formed in a section that is widened by repeatedly narrowing and widening the width between stripe type barrier ribs.

In a matrix type PDP, having hexagonal discharge cells arranged in a triangular form, three address electrodes that are vertically formed pass through each pixel including three discharge cells. Techniques for obtaining high definition and high brightness have been continuously developed for the plasma display device. In practice, to achieve a high definition screen, the number of horizontally arranged pixels and a pixel density increase, thereby increasing the number of address electrodes.

However, unlike sustain electrodes, when many address electrodes are present, power consumption increases due to the characteristics of the address electrodes, and a heat release rate increases. In the sustain electrodes, a circuit can be constructed such that power can be easily collected and recycled since a common waveform alternately changes. However, in the address electrodes, since a great amount of power is consumed through discharge, the number of address electrodes affects the power and the heat release rate.

In particular, when the number of the address electrodes increases, and the gap between the address electrodes decreases, a parasitic capacitance increases. As a result, a power consumption and a heat release rate for each address electrode which can be estimated from CV²f rise sharply and signal characteristics may be deteriorate, where C is a coefficient of capacity, v is a voltage applied to an address electrode, and f is a frequency.

In addition, when the number of the address electrodes increases, there are more required expensive elements such as tape carrier packages (TCP) for driving the address electrodes. In practice, the number of control terminals for controlling all of the electrodes is limited in an integration circuit board, which makes it difficult in selecting circuit elements and designing a driving board. Accordingly, the plasma display device may not be easily designed and manufactured. Therefore, there is a need for a technique in which the number of address electrodes is reduced while resolution or the number of pixels is maintained to be the same.

### SUMMARY OF THE INVENTION

The present invention provides a Plasma Display Panel (PDP) having an electrode structure that can reduce the number of address electrodes required for driving pixels while the number of the pixels is maintained to be the same.

The present invention also provides a PDP capable of maintaining the same degree of pixel density and reducing power consumption and component costs.

According to an aspect of the present invention, a PDP is provided in which an average of 1.5 address electrodes are assigned to each pixel arranged horizontally, and at least four sustain electrodes pass through each of the pixels.

According to one aspect of the present invention, a Plasma Display Panel (PDP) is provided including: two substrates; barrier ribs arranged between the two substrates and defining a space between the two substrates to form groups of at least three discharge cells; a group of electrodes arranged on at least one of the two substrates or the barrier ribs and adapted to induce a discharge in a group of the at least three discharge cells; a phosphor layer arranged in a group of the at least three discharge cells; and a discharge gas filling the space of a group of the at least three discharge cells; a group of the at least three discharge cells are adjacent one another and are arranged in a triangle to define one pixel; a plurality of pixels are arranged in a first direction; an average of 1.5 address electrodes are assigned belonging to the group of electrodes and have a specific angle in the first direction with respect to a surface parallel to the two substrates; and at least four sustain electrodes related to a sustain discharge from the group of electrodes pass through each pixel.

The plurality of pixels are preferably arranged in either a delta shape or a nabla shape; the plurality of pixels are preferably arranged in the first direction by alternately arranging delta shape and nabla shape pixels; and two of the address electrodes preferably pass through each of the pixels.

The plurality of pixels arranged in the first direction preferably include two rows of the plurality of discharge cells arranged adjacent to each other in a second direction having a specific angle with respect to the first direction on a surface parallel to the two substrates; discharge cells of the plurality of discharge cells emitting three colors of light beams are preferably sequentially and cyclically arranged in the rows of discharge cells, the rows adjacent each other in the second direction being shifted by ½ cycle in the first direction upon an entire width of the discharge cell emitting the three colors of light beams being defined to be 1 cycle; and the address electrodes are preferably respectively assigned one by one to each discharge cell of the rows of discharging cells, and two of the sustain electrodes pass therethrough.

The discharge cells are preferably in a hexagonal or rectangular form.

The address electrodes are preferably perpendicular to the first direction, and pass between vertical barrier ribs that are parallel to the address electrodes with respect to a direction perpendicular to the substrates.

A branch electrode that branches off from the address electrodes is preferably included within the discharge cells through which the address electrodes pass. The branch electrode preferably branches off from the address electrodes towards the center of the respective discharge cells.

Each sustain electrode preferably includes a scan electrode and a common electrode alternately arranged in the second direction perpendicular to the first direction. Each sustain electrode preferably passes through only one row of discharge cells arranged in the first direction. Each sustain electrode preferably includes a bus electrode and a transparent electrode, the transparent electrode in contact with the bus electrode and wider than the bus electrode. Each sustain electrode preferably includes two common electrodes horizontally passing through upper and lower portions of each respective discharge cell arranged in the first direction and a scan electrode horizontally passing through a center of each respective discharge cell.

According to another aspect of the present invention, a Plasma Display Panel (PDP) is provided including: two substrates; barrier ribs arranged between the two substrates and defining a space between the two substrates to form groups of at least three discharge cells; a group of electrodes arranged on at least one of the two substrates or the barrier ribs and adapted to induce a discharge in a group of the at least three discharge cells; a phosphor layer arranged in a group of the at least three discharge cells; and a discharge gas filling the space of a group of the at least three discharge cells; a group of the at least three discharge cells are adjacent one another and are arranged in a triangle to define one pixel; a plurality of pixels are arranged in a first direction; a ratio of the number of address electrodes belonging to the group of electrodes and have a specific angle in the first direction with respect to a surface parallel to the substrates, with respect to the number of sustain electrodes arranged in the first direction and related to a sustain discharge, is either 3:8 or 1:4.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic plan view of an electrode structure of each pixel of an example of a matrix type PDP;

FIG. 2 a schematic plan view of an electrode structure of each pixel of an example of a PDP having hexagonal discharge cells arranged in a triangular form;

FIG. 3 is a schematic plan view of a Plasma Display Panel (PDP) according to an embodiment of the present invention; and

FIG. 4 is a schematic plan view of a PDP according to another embodiment of the present invention.

### DETAILED DESCRIPTION OF THE INVENTION

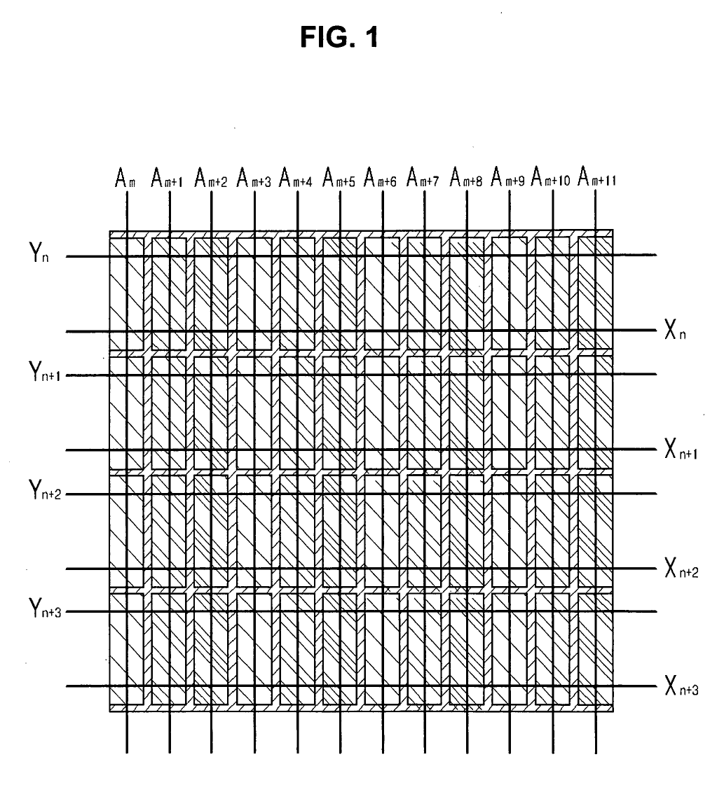

FIG. 1 is a schematic plan view of an electrode structure of each pixel of an example of a matrix type PDP.

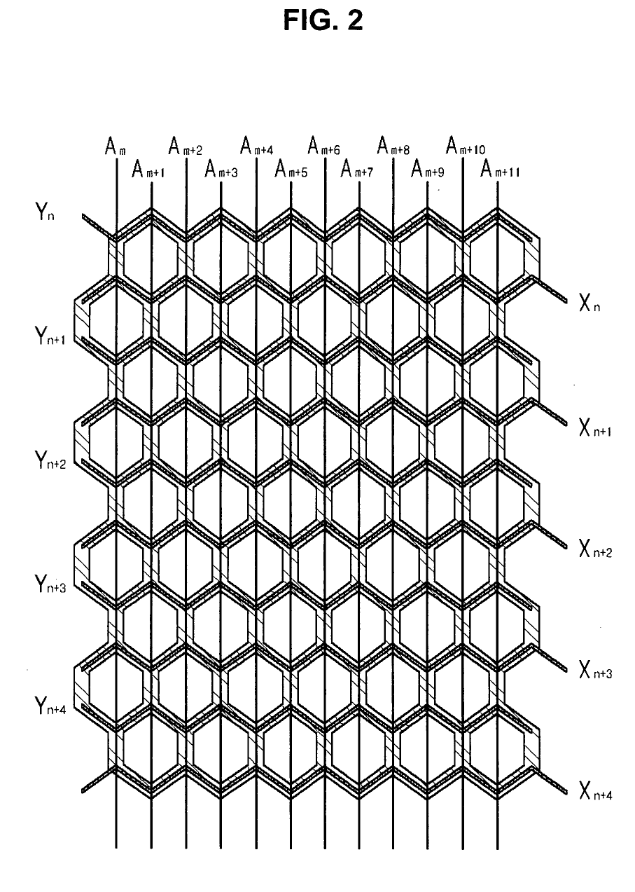

FIG. 2 a schematic plan view of an electrode structure of each pixel of an example of a Plasma Display Panel (PDP) having hexagonal discharge cells arranged in a triangular form.

In these PDPs, three address electrodes A that are vertically formed pass through each pixel including three discharge cells. Techniques for obtaining high definition and high brightness have been continuously developed for the plasma display device. In practice, to achieve a high definition screen, the number of horizontally arranged pixels and a pixel density increase, thereby increasing the number of address electrodes A.

However, unlike sustain electrodes X and Y, when many address electrodes are present, power consumption increases due to the characteristics of the address electrodes, and a heat release rate increases. In the sustain electrodes X and Y, a circuit can be constructed such that power can be easily collected and recycled since a common waveform alternately changes. However, in the address electrodes A, since a great amount of power is consumed through discharge, the number of address electrodes A affects the power and the heat release rate.

Embodiments of the present invention are described in detail below with reference to the attached drawings.

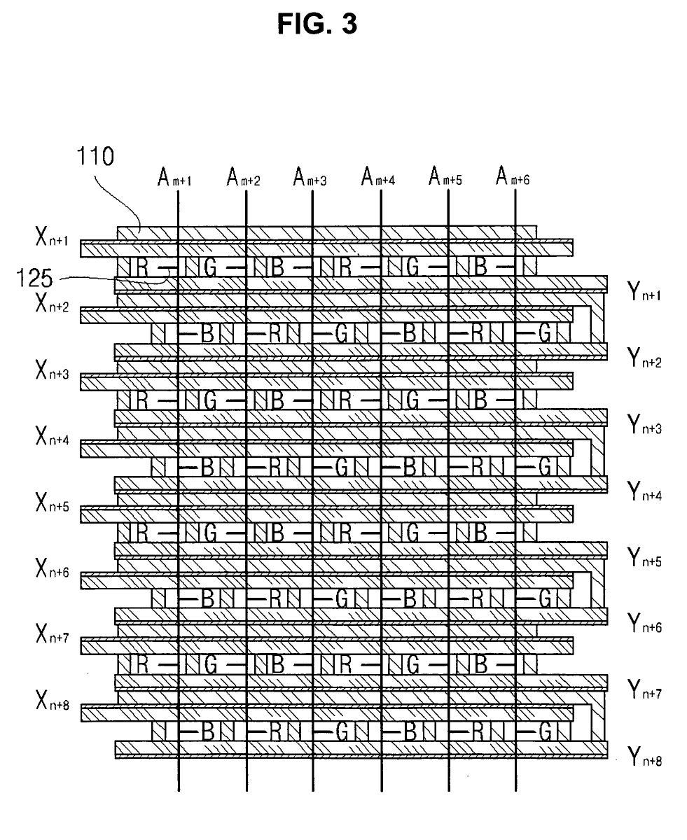

FIG. 3 is a schematic plan view of a PDP according to an embodiment of the present invention.

Referring to FIG. 3, each discharge cell has a rectangular formed by barrier ribs 110, and three discharge cells disposed up and down in two rows are combined to form a pixel arranged in a triangular form. In one row of discharge cells, three types of discharge cells emitting three types of visible light beams, for example, red (R), green (G), and blue (B), are sequentially disposed in a first direction, or in a horizontal direction with respect to a screen in the present embodiment. Furthermore, in another row under the aforementioned row, the light beams of R, G, and B are sequentially and cyclically arranged. The half width of one cycle having R, G, and B components is shifted in the first direction, that is, in the horizontal direction.

Two horizontally adjacent discharge cells in the upper row, for example, R and G, form a nabla (∇) shape together with a discharge cell in the lower row adjacent to the two discharge cells, thereby forming a pixel. A next discharge cell in the upper row, for example, B, forms a horizontally arranged delta (Δ) shape together with two discharge cells in a lower row adjacent to this discharge cell, for example, R and G, thereby forming a next pixel. These two triangular shapes are cyclically repeated to form an overall horizontal pixel arrangement.

Address electrodes (A:Aₘ₊₁, . . . ) formed in a second direction having a specific angle with respect to the first direction, or in a vertical direction of FIG. 3, are formed within a surface parallel to a substrate surface. From the viewpoint of one discharge row, one address electrode A is assigned to one discharge cell. However, from the viewpoint of a pixel unit, six address electrodes A vertically formed in the second direction (i.e. vertically direction) are assigned to four pixels formed in the first direction (i.e. horizontal direction). Thus, the number of the address electrodes assigned to each pixel is 1.5 in average. As a result, the number of the address electrodes for each pixel is reduced by half, in comparison with the arrangement of FIG. 2.

The address electrodes A are located in a stripe shape, between vertically formed barrier ribs among the barrier ribs 110 defining discharge cells. Specifically, the address electrodes A pass between the vertically formed barrier ribs located in adjacent upper and lower rows, so that the address electrodes A do not overlap vertically formed barrier ribs. To enhance discharge accuracy, a branch electrode 125 is formed perpendicular to a main address electrode A in a center direction of vertically formed discharge cells. Thus, branch electrodes 125 which are adjacent up and down in one address electrode are directed in opposite directions. The shape of the branch electrodes 125, the number of the branch electrodes 125, and the angle with respect to the main address electrode A can change in form. The address electrodes are generally formed in the rear substrate, and a dielectric layer, a barrier rib, and a phosphor layer can be formed on the rear substrate on which the electrodes are formed.

Sustain electrodes X and Y are formed horizontally in FIG. 3, and are parallel to the horizontal barrier ribs 110 defining each discharge cell. Specifically, in the present embodiment, when a plurality of horizontal barrier ribs is vertically arranged, common electrodes (X:X_{N+1}) and scan electrodes (Y:Yₘ₊₁) are disposed one by one in a discharge cell space between the barrier ribs. Consequently, one address electrode A and one scan electrode Y pass through one discharge cell. Thus, each discharge cell can be independently driven irrespective of other discharge cells, and a pixel that is a combination of discharge cells can be independently driven irrespective of other pixels.

The sustain electrodes X and Y include a bus electrode which comes in contact with a barrier rib on a surface of the front substrate and has a narrow width, and a transparent bus which comes in contact with or overlaps with the bus electrode and has a wide width that is extended by a specific width in a center direction of the discharge cell. Although not shown, the sustain electrodes can be formed only with a good conductive electrode without additionally using a transparent electrode. Since a discharge cell is minimized to cope with a high definition panel, the sustain electrodes can be formed not on the surface of a substrate but rather formed in both lateral sides of a barrier rib for a face discharge. In this case, to avoid a dielectric breakdown due to the barrier rib 110 the thickness and permittivity of the barrier rib 100 have to be taken into account.

In the present embodiment, four sustain electrodes X and Y, which are two common electrodes X and two scan electrodes Y, are assigned through two upper and lower discharge cells which form a pixel by combining discharge cells. In a screen area where four pixels are horizontally arranged and four pixels are vertically arranged, the total number of vertically formed address electrodes (A:Aₘ₊₁. . . ) is 6, and the total number of horizontally formed sustain electrodes is 16, that is, 8 common electrodes (X:X_{N+1}) and 8 scan electrodes (Y:Y_{M+1}). Thus,
the ratio of the number of the address electrodes with respect to the number of the sustain electrodes is 3:8. In comparison with the previously described case, for the same number of pixels, the number of address electrodes is reduced by ½ and the number of sustain electrodes is doubled.

According to this electrode arrangement, the number of the sustain electrodes increases, but overall power consumption is reduced since power supplied through the sustain electrodes are circulated, thereby recyclable. The number of the expensive Tape Carrier Packages (TCPs) for driving the address electrodes can be also reduced, resulting in saving component costs. In a 4:3 screen or a 16:9 screen, the number of the address electrodes is generally greater than the number of the scan electrodes. Considering the size of a circuit board for controlling each electrode terminal, in terms of a driving circuit design, it is preferable to increase the number of the scan electrodes that can be further increased, rather than increasing the number of the address electrodes that have little space left on the board.

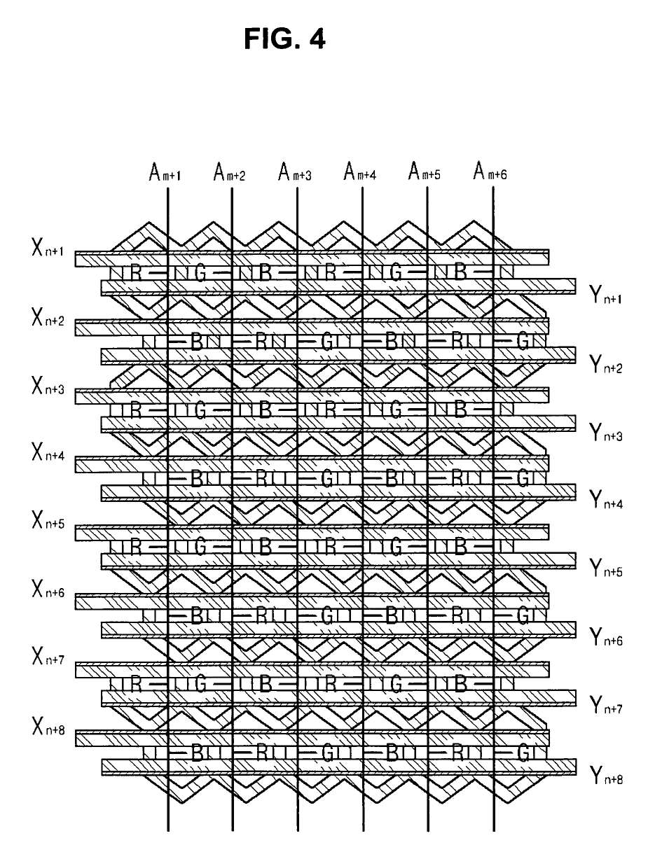

FIG. 4 is a schematic plan view of a PDP according to another embodiment of the present invention.

Most elements of FIG. 4 have the same pattern as in the embodiment of FIG. 3 except that each discharge cell has a hexagonal form, and barrier ribs are formed so that three discharge cells disposed up and down in adjacent rows are combined to form a pixel arranged in a triangular form. In a first row of discharge cells, three types of discharge cells emitting three types of visible light beams (i.e. R, G, and B) are sequentially and cyclically arranged. Furthermore, in a second row adjacent under the first row, the visible light beams are cyclically arranged. The half width of one cycle having R, G, and B components is horizontally shifted.

From the viewpoint of one discharge row, one address electrode is assigned to one discharge cell. However, from the viewpoint of a pixel unit, six address electrodes formed vertically are assigned to four pixels formed horizontally. Thus, the number of the address electrodes assigned to each pixel is 1.5 in average.

The address electrodes form a stripe shape, and are located between barrier ribs that are formed vertically in a hexagonal form to define discharge cells. In each address electrode, a branch electrode is formed in a center direction of discharge cells through which the address electrodes pass. An address discharge can take place in a wider area of the discharge cell due to the branch electrode. The branch electrode can also allow a display discharge to take place in a wider area.

A sustain electrode is formed horizontally, and does not overlap barrier ribs that form a hexagonal discharge cell in a zigzag manner, and passes through upper and lower portions of vertically formed barrier ribs while two sustain electrodes, that is, a scan electrode and a common electrode, are separated from each other by a specific distance in each hexagonal discharge cell. In the present embodiment, the sustain electrode has a wide width and is made of one material, but as shown in FIG. 3, the sustain electrode can include a bus electrode and a transparent electrode that extends by a specific width towards the center of upper and lower discharge cells in contact with the bus electrode.

In the present embodiment, as in the embodiment of FIG. 3, in a screen area where four pixels are horizontally arranged and four pixels are vertically arranged, the total number of vertically formed address electrodes is 6, and the total number of horizontally formed sustain electrodes is 16, that is, 8 common electrodes and 8 scan electrodes. Thus, the ratio of the number of the address electrodes with respect to the number of the sustain electrodes is 3:8.

Although not shown, an intermediate electrode can be formed in another embodiment. In such embodiment, most elements are the same as in the embodiment of FIG. 3. In the embodiment of FIG. 3, a sustain electrode horizontally passing through each discharge cell includes a scan electrode and a common electrode, and each sustain electrode includes a bus electrode that leans towards the barrier rib and a transparent electrode of which width extends towards the center of the discharge cell in the bus electrode. However, in the present embodiment, the sustain electrode includes only a metal electrode that leans towards upper and lower barrier ribs. An intermediate electrode that passes horizontally through the center of the discharge cell is formed between the metal electrodes, thereby functioning as a scan electrode. The scan electrode also can function as the sustain electrode according to whether a voltage is supplied while a sustain discharge takes place. In the present embodiment, the total number of the address electrodes is 6, and the total number of the sustain electrodes is 24. Thus, the ratio of the number of address electrodes and the number of sustain electrodes, which are assigned to one pixel, is 1:4 in average.

The plane structure of FIGS. 3 and 4 can be formed by constructing a layer structure in various ways. For example, an electrode can be formed only on a front or rear substrate constituting a panel. Alternatively, the electrode can be formed on two substrates. Furthermore, since the distance between discharge electrodes becomes short as high definition becomes more prevalent, to increase discharge efficiency, two types of sustain electrodes can be formed on barrier ribs to obtain a long gap and a face discharge type panel in which the distance between discharge electrodes is extended.

Additionally, the address electrode can be formed in such a way that the rear substrate is opaquely formed with a metal layer, a dielectric layer and a barrier rib are formed thereon, and a phosphor layer is laminated thereon, thereby constituting the rear substrate. In the front substrate, two types of an electrode group constituting a sustain electrode are formed with a metal or a transparent conductive layer such as metal or Indium Tin Oxide (ITO), and a dielectric layer or a protective layer can be formed thereon. A layer pattern, such as an electrode layer or a barrier rib, can be formed using lithography or photolithography. The protecting layer or its equivalent can be formed by various methods, such as sputtering and deposition. Such structure and methods are well-known to those skilled in the art, and accordingly, a detailed description thereof has been omitted.

Considering theoretical factors, the following table compares a PDP according to an embodiment of the present invention with a PDP having a different barrier rib and electrode structure, in terms of the number of address electrodes, the number of TCPs that are driving ICs, the number of required address buffer boards, an address power consumption, a heat generation per address circuit, a critical power (instantaneous power) supplied to each address circuit, the number of scan electrodes, and the number of scan driving circuits.

The power consumption, heat generation, and critical power for each address electrode have been estimated for the worst case situation, while hexagonal meander and single scan have taken place.

A dual scan means that address driving is performed at both sides of the center in upper and lower portions, and a single scan means that address driving is performed at one side of the center in upper and lower portions. A stripe, a hexagonal discharge cell, and hexagonal meander indicate the structure of a barrier rib related to the shape of the discharge cell. FHD means a full high definition type.

| | | | | | Heat | | | |
|---|---|---|---|---|---|---|---|---|
| | | Number of | Number of | | generation | Critical | | |
| | Number of | electrodes | required | Power consumption | per | power per | Number of | Number of |
| | address | per each | buffer | per address | address | address | scan | scan driving |
| Type/item | electrodes | TCP | boards | electrode | electrode | electrode | electrodes | chips |
| Present | 2880 | 30 | 2 | 0.69 | 0.49 | 0.35 | 2160 | 34 |
| invention | | | | | | | | |
| stripe | 5760 | 60 | 2 | 1.39 | 0.49 | 0.7 | 1080 | 17 |
| Hexagonal | 5760 | 60 | 2 | 1.39 | 0.49 | 0.7 | 1080 | 17 |
| discharge | | | | | | | | |
| Hexagonal | 5760 | 30 | 1 | 2.78 | 1.98 | 1.41 | 1080 | 17 |
| meander | | | | | | | | |
| Hexagonal | 4098 | 21 | 1 | 1 | 1 | 1 | 768 | 12 |
| meander | | | | | | | | |
| Hexagonal | 3840 | 20 | 1 | 0.82 | 0.88 | 0.94 | 720 | 12 |
| meander | | | | | | | | |

This table shows that the present invention is advantageous over the prior art in terms of the number of address electrodes, the number of required TCPs, power consumption per address electrode, heat generation per address electrode, and critical power per address electrode.

Accordingly, in a PDP of the present invention, the number of address electrodes for implementing a screen having the same horizontal resolution and the number of driving circuit chips required to drive the address electrodes can be reduced.

Therefore, the number of address electrodes, which consume power and generate heat the most in the PDP, can be reduced, thereby reducing overall power consumption and heat release rate.

What is claimed is:

1. A Plasma Display Panel (PDP), comprising:
two substrates;
barrier ribs arranged between the two substrates and defining a space between the two substrates to form groups of at least three discharge cells;
a group of electrodes arranged on at least one of the two substrates or the barrier ribs and adapted to induce a discharge in a group of the at least three discharge cells;
a phosphor layer arranged in a group of the at least three discharge cells; and
a discharge gas filling the space of a group of the at least three discharge cells;
wherein a group of the at least three discharge cells are adjacent one another and are arranged in a triangle to define one pixel;
wherein a plurality of pixels are arranged in a first direction;
wherein an average of 1.5 address electrodes are assigned to each pixel of the plurality of pixels, the address electrodes belong to the group of electrodes and have a specific angle to the first direction with respect to a surface parallel to the two substrates; and
wherein at least four sustain electrodes related to a sustain discharge from the group of electrodes pass through each pixel.

2. The PDP according to claim 1, wherein the discharge cells defining a pixel are arranged in either a delta shape or a nabla shape;
wherein the plurality of pixels are arranged in the first direction by alternately arranging delta shape and nabla shape pixels; and
wherein two of the address electrodes pass through each of the pixels.

3. The PDP according to claim 1, wherein the plurality of pixels arranged in the first direction include two rows of the plurality of discharge cells arranged adjacent to each other in a second direction having a specific angle with respect to the first direction on a surface parallel to the two substrates;
wherein discharge cells of the plurality of discharge cells emitting three colors of light beams are sequentially and cyclically arranged in the rows of discharge cells, the rows adjacent each other in the second direction being shifted by ½ cycle in the first direction upon an entire width of the discharge cell emitting the three colors of light beams being defined to be 1 cycle;
and
wherein the address electrodes are respectively assigned one by one to each discharge
cell of the rows of discharging cells, and two of the sustain electrodes pass therethrough.

4. The PDP according to claim 1, wherein the discharge cells are in a hexagonal or rectangular form.

5. The PDP according to claim 2, wherein the address electrodes are perpendicular to the first direction, and pass between vertical barrier ribs that are parallel to the address electrodes with respect to a direction perpendicular to the substrates.

6. The PDP according to claim 3, wherein the address electrodes are perpendicular to the first direction, and pass between vertical barrier ribs that are parallel to the address electrodes with respect to a direction perpendicular to the substrates.

7. The PDP according to claim 2, wherein a branch electrode that branches off from the address electrodes is included within the discharge cells through which the address electrodes pass.

8. The PDP according to claim 3, wherein a branch electrode that branches off from the address electrodes is included within the discharge cells through which the address electrodes pass.

9. The PDP according to claim 7, wherein the branch electrode branches off from the address electrodes towards the center of the respective discharge cells.

10. The PDP according to claim 8, wherein the branch electrode branches off from the address electrodes towards the center of the respective discharge cells.

11. The PDP according to claim 1, wherein each sustain electrode comprises a scan electrode and a common electrode alternately arranged in the second direction perpendicular to the first direction.

12. The PDP according to claim 11, wherein each sustain electrode passes through only one row of discharge cells arranged in the first direction.

13. The PDP according to claim 11, wherein each sustain electrode comprises a bus electrode and a transparent electrode, the transparent electrode in contact with the bus electrode and wider than the bus electrode.

14. The PDP according to claim 1, wherein each sustain electrode comprises two common electrodes horizontally passing through upper and lower portions of each respective discharge cell arranged in the first direction and a scan electrode horizontally passing through a center of each respective discharge cell.

15. A Plasma Display Panel (PDP), comprising:
two substrates;
barrier ribs arranged between the two substrates and defining a space between the two substrates to form groups of at least three discharge cells;
a group of electrodes arranged on at least one of the two substrates or the barrier ribs and adapted to induce a discharge in a group of the at least three discharge cells; a phosphor layer arranged in a group of the at least three discharge cells; and
a discharge gas filling the space of a group of the at least three discharge cells;
wherein a group of the at least three discharge cells are adjacent one another and are arranged in a triangle to define one pixel;
wherein a plurality of pixels are arranged in a first direction;
wherein a ratio of the number of address electrodes belonging to the group of electrodes and have a specific angle in the first direction with respect to a surface parallel to the substrates, with respect to the number of sustain electrodes arranged in the first direction and related to a sustain discharge, is either 3:8 or 1:4.
